(19) United States
(12) Patent Application Publication
(10) Pub. No.: US 2023/0122666 A1
(43) Pub. Date: Apr. 20, 2023

(54) CLOUD XR-BASED PROGRAM VIRTUALIZING METHOD

(71) Applicant: IMMERSIVECAST CO., LTD., Seongnam-si (KR)

(72) Inventors: Jang Hee HAN, Seongnam-si (KR); Kwang Il JUNG, Seoul (KR); Jae Hyeon JOO, Suwon-si (KR)

(73) Assignee: IMMERSIVECAST CO., LTD., Seongnam-si (KR)

(21) Appl. No.: 17/878,927

(22) Filed: Aug. 2, 2022

(30) Foreign Application Priority Data
Oct. 15, 2021 (KR) 10-2021-0137640

(51) Int. Cl. H04L 67/131; G06T 19/00

(52) U.S. Cl. CPC H04L 67/131; G06T 19/006

(57) ABSTRACT

A cloud XR-based program virtualizing method, includes: executing an eXtended reality (XR) application implemented to execute an application in a three-dimensional (3D) virtual space on a cloud server; rendering a 3D virtual space while executing the XR application; generating a virtual space image based on the rendered 3D virtual space; encoding the generated virtual space image and transmitting the encoded virtual space image to a remote XR device; rendering an execution screen of the application when the application is executed; generating one 3D image by integrating the rendered 3D virtual space and the application program execution screen; and encoding the generated 3D image and transmitting the encoded 3D image to the XR device.

### CROSS REFERENCE TO PRIOR APPLICATIONS

This application claims priority to and the benefit Korean Patent Application No. 10-2021-0137640 filed on Oct. 15, 2021 which is hereby incorporated by reference in their entirety.

### BACKGROUND

The present disclosure relates to a cloud-based program virtualizing technology, and more specifically, to a cloud XR-based program virtualizing method capable of using a remote computer in a virtual space based on the cloud XR.

Virtual reality (VR) refers to a technology that artificially creates a specific environment or situation similar to the real one but not the real one through a computer or the like. In this case, the created virtual environment or situation stimulates user’s five senses and allows users to have a spatial and temporal experience similar to the real one to allow the users to freely enter and exit a boundary between reality and virtual reality. Users may not only immerse themselves in the created virtual reality, but also interact with objects implemented in the virtual reality, such as manipulating or giving commands using a real device.

The existing wired-based VR system or LTE-based VR system is difficult to effectively provide large-capacity VR contents to users in terms of a data transmission rate, response latency, and convenience.

5G networks have characteristics of a fast data transmission rate and an ultra-low latency response. The 5G network may transmit high-resolution graphics with ultra-low latency, and thus, is suitable for implementing a wireless VR system.

### Related Art Document

### Patent Document

(Patent Document 0001) Korean Patent No. 10-1990428 (Jun. 12, 2019)

### SUMMARY

An embodiment of the present disclosure is to provide a cloud XR-based program virtualizing method capable of using a remote computer in a virtual space.

An embodiment of the present disclosure is to a cloud XR-based program virtualizing method capable of processing a computing process on a remote server and streaming the processed result to an XR device through cloud virtualization, unlike the existing method of processing a computing process on an XR device.

An embodiment of the present disclosure is to provide a cloud XR-based program virtualizing method capable of allowing multiple users to perform tasks in a virtual space based on a cloud XR.

An exemplary embodiment of the present disclosure provides a cloud XR-based program virtualizing method including: executing an eXtended reality (XR) application implemented to execute an application in a three-dimensional (3D) virtual space on a cloud server; rendering a 3D virtual space while executing the XR application; generating a virtual space image based on the rendered 3D virtual space; encoding the generated virtual space image and transmitting the encoded virtual space image to a remote XR device; rendering an execution screen of the application when the application is executed; generating one 3D image by integrating the rendered 3D virtual space and the application program execution screen; and encoding the generated 3D image and transmitting the encoded 3D image to the XR device.

The rendering of the 3D virtual space may include rendering a virtual space including a personal room and a conference room.

The generating of the virtual space image may include: rendering a user personal identification object customized by the user; and generating a virtual space image including the user personal identification object based on the rendered user personal identification object and the 3D virtual space.

The generating of the virtual space image may further include rendering a participant personal identification object customized by a participant who accesses the virtual space, and the generating of the virtual space image including the personal identification object may include generating a virtual space image including the user personal identification object and the participant personal identification object.

The rendering of the execution screen may include: transmitting an execution request signal to the user computing device when the execution request signal of an application installed in a remote user computing device is received; receiving capture data captured while executing the application program in the user computing device; and rendering the execution screen of the application program based on the received capture data.

The capture data may be process capture data obtained by capturing a process for each individual program executed in the user computing device.

The capture data may be screen capture data obtained by capturing the screen of the user computing device.

The transmitting of the execution request signal to the user computing device may include receiving the execution request signal from the XR device.

The rendering of the execution screen may include: executing the application program when the execution request signal of the application installed on the cloud server is received; and rendering the execution screen of the application program.

The application program may include a memo program, a whiteboard program, a screen program, a 3D viewer program, a voice chat program, a pointer program, a keyboard input program, or an object tracking program.

Another exemplary embodiment of the present disclosure provides a cloud XR-based program virtualizing method including: executing an eXtended reality (XR) application implemented to execute an application in a three-dimensional (3D) virtual space on a cloud XR platform installed in a user computing device; rendering a 3D virtual space while executing the XR application; generating a virtual space image based on the rendered 3D virtual space; encoding the generated virtual space image and transmitting the encoded virtual space image to a remote XR device; receiving capture data captured during an execution of an application program in the user computing device; rendering an execution screen of the application program based on the capture data; generating one 3D image by integrating the rendered 3D virtual space and the application program execution screen according to control; and encoding the generated 3D image and transmitting the encoded 3D image to the XR device.

The disclosed technology may have the following effects. However, since a specific embodiment is not construed as including all of the following effects or only the following effects, it should not be understood that the scope of the disclosed technology is limited to the specific embodiment.

According to a cloud XR-based program virtualizing method according to an embodiment of the present disclosure, it is possible to use a remote computer in a virtual space.

According to a cloud XR-based program virtualizing method according to an embodiment of the present disclosure, it is possible to process a computing process on a remote server through cloud virtualization and streams the processed result to an XR device to smoothly use existing the business programs commonly used in the past and easily configure a virtual space that meets user’s requirements.

According to a cloud XR-based program virtualizing method according to an embodiment of the present disclosure, it is possible to enable multiple users to perform tasks in a virtual space in a manner similar to collaboration in the real world.

### BRIEF DESCRIPTION OF THE DRAWINGS

FIG. 1 is a diagram illustrating a cloud XR-based program virtualizing system according to an embodiment of the present disclosure.

FIG. 2 is a diagram for explaining a system configuration of a cloud server of FIG. 1.

FIG. 3 is a diagram for explaining a functional configuration of the cloud XR-based program virtualizing system of FIG. 1 according to an embodiment of the present disclosure.

FIG. 4 is a diagram illustrating a cloud XR-based program virtualizing system according to another embodiment of the present disclosure.

FIG. 5 is a diagram for explaining a functional configuration of the cloud XR-based program virtualizing system of FIG. 4 according to another embodiment of the present disclosure.

FIG. 6 is a flowchart illustrating an embodiment of a cloud XR-based program virtualizing method according to the present disclosure.

FIG. 7 is a flowchart for explaining another embodiment of a cloud XR-based program virtualizing method according to the present disclosure.

### DETAILED DESCRIPTION

The description of the present disclosure is merely an example for structural or functional explanation, and the scope of the present disclosure should not be construed as being limited to the embodiments set forth herein. That is, the embodiments are to be construed as being variously embodied and having various forms, so that the scope of the present invention should be understood to include equivalents capable of realizing technical ideas. Also, the purpose or effect of the present invention should not be construed as limiting the scope of the present invention, since it does not mean that a specific embodiment should include all or only such effect.

Meanwhile, the meaning of the terms described in the present application should be understood as follows.

The terms “first ”,“ second ”, and the like are intended to distinguish one element from another, and the scope of the right should not be limited by these terms. For example, the first component may be referred to as a second component, and similarly, the second component may also be referred to as a first component.

When one element is described as being “connected” to another element, it shall be construed as being connected or accessed to another element directly but also as possibly having yet another element in between. On the other hand, if one element is described as being “directly connected” to another element, it shall be construed that there is no other element in between. This is also true of other expressions for explaining a relationship between elements, i.e., “between” and “directly between” or “adjacent to” and “directly adjacent to”.

Unless clearly used otherwise, expressions in the singular number include a plural meaning. In the present description, an expression such as “comprising”, “including”, or “having” is intended to designate a characteristic, a number, a step, an operation, an element, a part or combinations thereof, and shall not be construed to preclude any presence or possibility of one or more other characteristics, numbers, steps, operations, elements, parts or combinations thereof.

Identification codes (e.g., a, b, and c) of each step are merely used for better comprehension and ease of description, not indicating a specific order of the steps, and the steps may be performed in a different order from a described order, unless clearly limited otherwise. Specifically, the steps may be performed in the same order as the described order, may substantially simultaneously be performed, or may be performed in the reverse order.

The present disclosure may be embodied as computer-readable code in a computer readable recording medium, and the computer-readable recording medium may include all kinds of recording devices for storing data that is readable by a computer system. Examples of the computer-readable recording medium include a ROM, a RAM, a CD-ROM, a magnetic tape, a floppy disk, an optical data storage device, and the like. Further, the computer-readable recording medium may be distributed to a computer system connected via a network and thus store and execute computer-readable code in a distributed manner

Unless otherwise defined, all terms used herein have the same meaning as how they are generally understood by those of ordinary skill in the art to which the disclosure pertains. Any term that is defined in a general dictionary shall be construed to have the same meaning in the context of the relevant art, and, unless otherwise defined explicitly, shall not be interpreted to have an idealistic or excessively formalistic meaning.

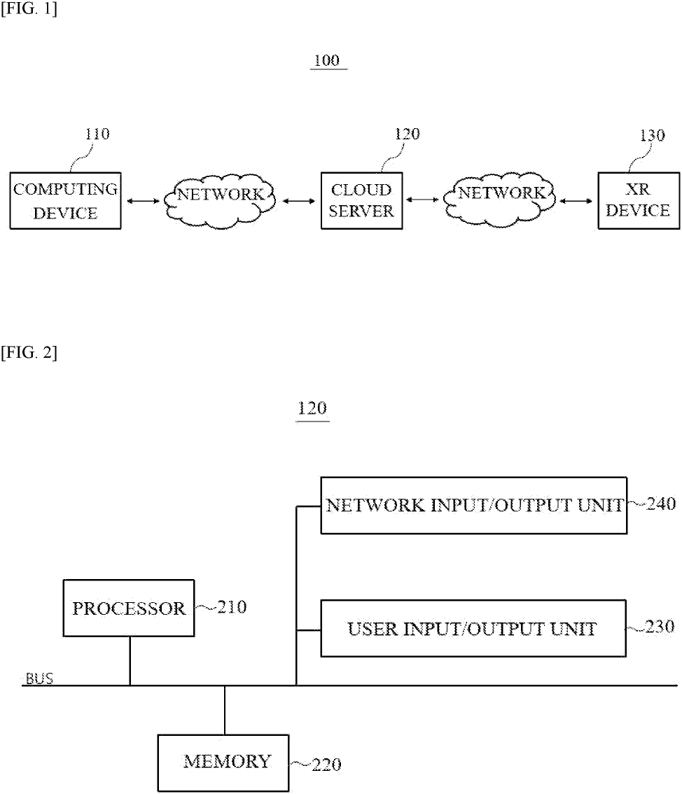

FIG. 1 is a diagram illustrating a cloud eXtended reality (XR)-based program virtualizing system according to the present disclosure.

Referring to FIG. 1, a program virtualizing system 100 may include a user computing device 110, a cloud server 120, and an eXtended Reality (XR) device 130.

The user computing device 110 may correspond to a computer controlled by a user. For example, the user computing device 110 may correspond to a user’s PC, notebook, tablet PC, or the like. The user computing device 110 may be connected to the cloud server 120 through a network to exchange data. In an embodiment, the user computing device 110 may be connected to the cloud server 120 through a wireless network such as Bluetooth, WiFi, 5G communication, and may transmit/receive data to and from the cloud server 120 through the network.

The user computing device 110 is operated by an operating system (OS), and may execute various application programs and process processes on the OS. In addition, the user computing device 110 may be implemented to operate through the cloud XR-based program virtualizing method according to the present disclosure. To this end, the user computing device 110 may operate by interworking with the cloud server 120. The user computing device 110 may operate by interworking with the cloud server 120 to execute an application program, and capture a process for each individual program while executing the application program. Alternatively, the user computing device 110 may capture an execution screen while executing the application program. The user computing device 110 may generate capture data and transmit the generated capture data to the cloud server 120. To this end, the user computing device 110 may install and execute an XR application (agent) that operates by interworking with the cloud server 120.

In an embodiment, the user computing device 110 may receive an application program execution request signal from the cloud server 120. In another embodiment, the user computing device 110 may receive the application program execution request signal from the XR device 130.

The XR device 130 may correspond to a user terminal capable of reproducing augmented reality (AR)/virtual reality (VR) images. Here, the XR device 130 may be implemented as a head mounted display (HMD) terminal, AR Glass, etc., but is not necessarily limited thereto, and may be implemented as various devices capable of reproducing VR/AR images. The XR device 130 may be connected to the cloud server 120 through a network to exchange data.

The XR device 130 may be implemented to operate through a cloud XR-based program virtualizing method according to the present disclosure. To this end, the XR device 130 may operate by interworking with the cloud server 120. That is, the XR device 130 may reproduce a three-dimensional (3D) image received from the cloud server 120 by interworking with the cloud server 120.

In an embodiment, the XR device 130 may reproduce a 3D virtual space and reproduce a 3D image in which an application program execution screen is integrated in the 3D virtual space. In an embodiment, the XR device 130 may perform a specific operation for virtualization of a cloud XR-based program according to the present disclosure while reproducing the 3D virtual space.

For example, the XR device 130 may generate virtual input means (e.g., a virtual keyboard, a virtual mouse, etc.) in a virtual space under the control of the user and receive a user’s command through the virtual input means. In another embodiment, the XR device 130 may receive a user’s command through hardware input means (e.g., a Bluetooth keyboard, a Bluetooth mouse, etc.). In another embodiment, the XR device 130 may receive a user’s command through object tracking (e.g., hand tracking, head tracking, etc.). The XR device 130 may generate a signal (e.g., a command signal, a motion signal, an application program execution request signal, etc.) according to a command received through the input means and transmit the generated signal to the cloud server 120, and the cloud server 120 may receive the corresponding request signal, generate an execution screen of the corresponding application program, and transmit, to the XR device 130, a 3D image in which the application program execution screen is integrated in the 3D virtual space. At this time, the cloud server 120 may encode the generated 3D image and transmit the encoded 3D image to the XR device 130, and the XR device 130 may receive and decodes the 3D image. To this end, the XR device 130 may install and execute an XR application (client) that operates by interworking with the cloud server 120.

In an embodiment, the XR device 130 may be implemented to include a 6 degrees of freedom (DoF) sensor for user’s motion information. In addition, the XR device 130 may be implemented by further including various sensors as necessary. For example, the XR device 130 may further include a GPS sensor, a motion sensor, and the like. In another embodiment, the XR device 130 may receive user’s motion information from the 6 DoF sensor operating outside.

The cloud server 120 may be implemented as a server corresponding to a computer or program that transmits a 3D image including a virtual space to the XR device 130 through a network. In addition, the cloud server 120 may receive the request of the XR device 130 to directly execute the application program installed in the cloud server 120, and transmit, to the XR device 130, the 3D image in which the execution screen of the application program is integrated in the virtual space. In another embodiment, the cloud server 120 may receive the request of the XR device 130 to execute the application program installed in the remote user computing device 110, and transmit, to the XR device 130, the 3D image in which the execution screen of the corresponding application program is integrated in the virtual space based on the capture data received from the user computing device 110. In another embodiment, the user computing device 110 may receive a request from the XR device 130 and execute the application program installed in the corresponding user computing device 110 and may generate capture data while executing the application program and transmit the generated capture data to the cloud server 120, and the cloud server 120 may transmit, to the XR device 130, the 3D image in which the execution screen of the corresponding application program is integrated in the virtual space based on the capture data received from the user computing device 110.

The cloud server 120 may be connected to the XR device 130 through a wireless network such as Bluetooth, WiFi, and 5G communication, and may transmit/receive data to and from the XR device 130 through the network.

In addition, the cloud server 120 may receive the 6 DoF signal as the user’s motion information from the XR device 130, and generate an image responding to the user’s motion based on the received 6 DoF signal and transmit the generated image to the XR device 130. To this end, the cloud server 120 may install and execute an XR application that operates by interworking with the XR device 130.

FIG. 2 is a diagram for explaining a system configuration of a cloud server of FIG. 1.

Referring to FIG. 2, the cloud server 120 may be implemented including a processor 210, a memory 220, a user input/output unit 230, and a network input/output unit 240.

The processor 210 may execute a procedure for processing each step while operating the cloud server 120, manage the memory 220 to be read or written throughout the process, and may schedule a synchronization time between a volatile memory and a non-volatile memory in the memory 220. The processor 210 may control the overall operation of the cloud server 120, and may be electrically connected to the memory 220, the user input/output unit 230, and the network input/output unit 240 to control the flow of data therebetween. The processor 210 may be implemented as a central processing unit (CPU) of the cloud server 120.

The memory 120 is implemented as a non-volatile memory, such as a solid state drive (SSD) or a hard disk drive (HDD), and may include an auxiliary storage device used to store overall data necessary for the cloud server 120 and may include a main storage device implemented as a volatile memory such as random access memory (RAM).

The user input/output unit 230 may include an environment for receiving user input and an environment for outputting specific information to a user. For example, the user input/output unit 230 may include an input device including an adapter such as a touch pad, a touch screen, an on-screen keyboard, or a pointing device, and an output device including an adapter such as a monitor or a touch screen. In one embodiment, the user input/output unit 230 may correspond to a user computing device connected via remote access. In this case, the cloud server 120 may be performed as an independent server.

The network input/output unit 240 includes an environment for connecting with an external device or a system through a network, and may include an adapter for communications such as a local area network (LAN), a metropolitan area network (MAN), a wide area network (WAN), a value added network (VAN), and the like.

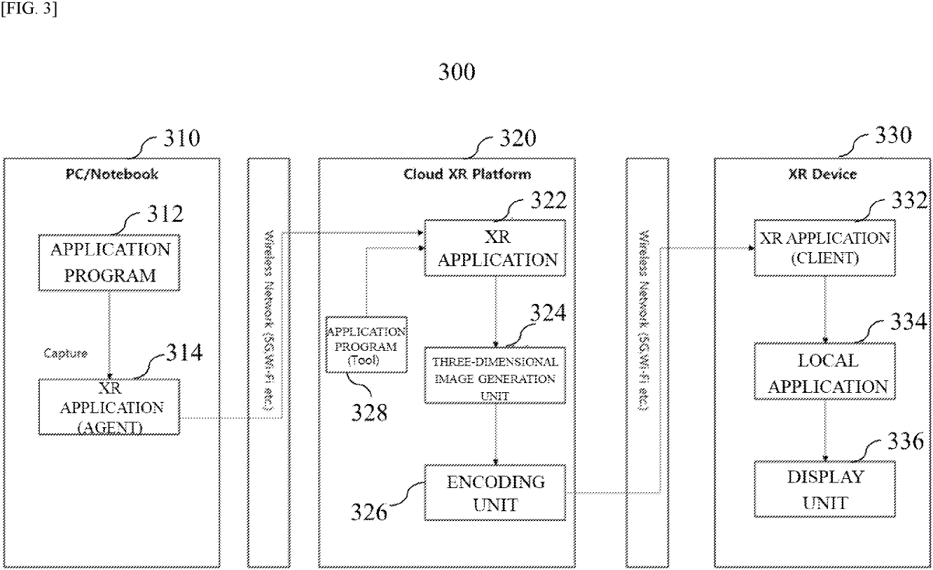

FIG. 3 is a diagram for explaining a functional configuration of the cloud XR-based program virtualizing system of FIG. 1 according to an embodiment of the present disclosure.

Referring to FIG. 3, a cloud XR-based program virtualizing system 300 may include a user computing device 310, a cloud server 320, and an XR device 330. The user computing device 310 includes an application program 312 and an XR application (agent) 314.

An application program 312 may be pre-installed on the user computing device 110. In one embodiment, the application program 312 may include various programs such as a business office program, an image/video editing program, a game program, an education program, a programming language program, and a web browser program. For example, an office program for business may include a word program, a spreadsheet program, a presentation program, and the like.

The user computing device 310 may download the XR application and install the XR application (agent) 314 under the control of the user. In an embodiment, the user computing device 110 may access a cloud XR service site and download a corresponding XR application.

The XR application (agent) 314 executes the application program 312 by interworking with the cloud server 320. When the information on the execution target application program 312 and the execution request signal of the corresponding application program 312 are received from the cloud server 320, the user computing device 310 executes the corresponding application program 312. The XR application (agent) 314 may capture processes for each individual program while executing the application program 312. Alternatively, the XR application (agent) 314 may capture the execution screen while executing the application program 312. The XR application (agent) 314 may generate capture data and transmit the generated capture data to the cloud server 320.

A cloud XR platform is installed in the cloud server 320, and the cloud XR platform may include an XR application 322, a 3D image generation unit 324, an encoding unit 326, and an application program 328. The cloud XR platform may generate a 3D virtual space according to a user’s request input through the user computing device 310 or the XR device 330, and may generate a URL that may access the 3D virtual space. The cloud XR platform may provide an image of the same 3D virtual space to at least one or more XR devices 330 connected to the corresponding URL.

The XR application 322 operates by interworking with the user computing device 310 and the XR device 330 to perform computing, processing, rendering, and the like. The cloud XR platform may execute the XR application according to the user’s request input through the user computing device 310 or the XR device 330. The XR application 322 renders the 3D virtual space while being executed. In one embodiment, the XR application 322 may render a virtual space including a personal room and a conference room. In one embodiment, the rendered virtual space may further include a 3D model conference room.

The personal room is a place where the user of the XR device 330 works with application applications of the user computing device 110 on a large multi-screen. The personal room is used for personal work, but in the personal room, work may also be performed by inviting colleagues as personal identification objects (e.g., avatar) to share screens. The personal room may be implemented with photorealistic graphics, and the large multi-screen may support 2D/3D to display objects or design products in 2D or 3D.

The XR application 322 may receive a command from the user’s XR device 330 through virtual input means such as a virtual keyboard and a virtual mouse, and input means such as object tracking (e.g., hand tracking, head tracking, etc.) to execute the application program 312 of the user computing device 310 or an application program (tool) 328 installed in the cloud XR platform or execute a command for the corresponding application program. The XR application 322 may arrange a user experience (UX)/user interface (UI) screen capable of executing the application program 312 of the user computing device 310 or the application program (Tool) 328 installed in the cloud XR platform in a 3D virtual space or may be arranged in the 3D virtual space by implementing the UX/UI through a virtual pad/smartphone, or the like.

The conference room is a space where multiple users may participate and collaborate just like a real conference room. When at least one user accesses the same 3D virtual space using the XR device 330 of the corresponding user, the XR application 322 may displayed the accessed user into a personal identification object (e.g., an avatar) in the conference room. The XR application 322 may express the user’s motion and state in the conference room through the personal identification object. In the conference room, a plurality of users may collaborate through the application program (tool) 328 installed in the cloud XR platform or the application program 312 of the user computing device 310. In one embodiment, the application program (tool) 328 may include a memo program, a white board program, a screen program, a 3D viewer program, a voice chat program, a pointer program, a keyboard input program, or an object tracking program.

For example, by executing the screen program, multiple users may share a presentation screen, and by executing the whiteboard program, meeting details may be recorded.

The 3D model conference room is a space where multiple users may participate and collaborate while creating 3D objects or sharing already created 3D objects. For example, a 3D screen may be implemented by executing the 3D viewer program, and multiple users may hold a conference while sharing 3D objects on the 3D screen.

The user computing devices 310 of at least one user connected to the same 3D virtual space may directly exchange data in a peer-to-peer manner. When a public IP is not allocated to the user computing devices 310 of the user, data may be directly exchanged in a peer-to-peer manner through a hole punching method.

The 3D image generation unit 324 generates a virtual space image based on the rendered 3D virtual space, and the encoding unit 326 encodes the generated virtual space image and transmits the encoded space image to the remote XR device 330. In an embodiment, the 3D image generation unit 324 may generate a virtual space image based on preset or input texture information and shader information.

In an embodiment, the XR application 322 may render a user personal identification object (e.g., avatar, personal character, etc.) customized by the user, and the 3D image generation unit 324 may generate the virtual space image including the user personal identification object based on the rendered user personal identification object and the 3D virtual space. In one embodiment, when there is more than one participant connected to the same 3D virtual space, the XR application 322 may render a participant personal identification object customized by the participant, and the 3D image generation unit 324 may generate a virtual space image including a user personal identification object and a participant personal identification object.

In an embodiment, when the application program (tool) 328 installed in the cloud XR platform or the application program 312 of the user computing device 310 is executed, the XR application 322 renders an execution screen of the corresponding application program. The 3D image generation unit 324 generates one 3D image by integrating the rendered 3D virtual space and the application program execution screen, and the encoding unit 326 encodes the generated 3D image and transmits the encoded 3D image to the XR device 330. For example, when the execution request signal of the application program installed in the remote user computing device 310 is received from the XR device 330, the XR application 322 transmits the execution request signal of the application program to the user computing device 310. Send a request signal. The XR application 322 receives capture data captured while executing the application program in the user computing device 310, and renders an execution screen of the application program based on the received capture data.

When the execution request signal of the application program installed on the cloud XR platform of the cloud server 320 is received from the XR device 330, the XR application 322 executes the corresponding application program and renders the execution screen of the corresponding application program.

The XR device 330 may include an XR application (client) 332, a local application 334, and a display unit 336.

The cloud server 320 transmits the 3D image to the XR device 330, and the XR device 310 may decode and reproduce the received 3D image. On the other hand, the cloud XR-based program virtualizing method according to the present disclosure may be independently performed through the XR device 330, and thus, even a low-specification XR device 330 may provide a high-resolution XR image capable of accurately expressing color, texture, etc.

The XR device 330 may install and execute the XR application (client) 332 that operates BY interworking with the cloud server 120.

The XR application (client) 332 interworks with the cloud server 320 under the user’s control to access the 3D virtual space through the URL, and receives the 3D image from the cloud server 320. The XR application (client) 332 may generate a signal (e.g., a command signal, a motion signal, an application program execution request signal, etc.) according to the received command and transmit the generated signal to the cloud server 320.

The local application 334 executes basic operations and functions of the XR device 330. The local application 334 may decode the 3D image received through the XR application (client) 332.

In one embodiment, the local application 334 may receive a command through virtual input means such as a virtual keyboard and a virtual mouse, hardware input means (e.g., Bluetooth keyboard, Bluetooth mouse, etc.), and input means such as object tracking (e.g., hand tracking, head tracking, etc.).

For example, the local application 334 may generate a virtual keyboard in a 3D virtual space displayed through the display unit 336 to provide a command input function in the virtual space. The virtual keyboard may interwork with the hand tracking function to input a command using a user’s hand on a keyboard in the virtual space.

The local application 334 is connected to the Bluetooth keyboard and transmits the input command to the XR application (client) 332 when the user types the keyboard. When using the XR device 330 supporting the hand tracking, the local application 334 may receive a motion-based command through the hand tracking.

The display unit 336 displays the decoded 3D image so that a user may experience the 3D virtual space.

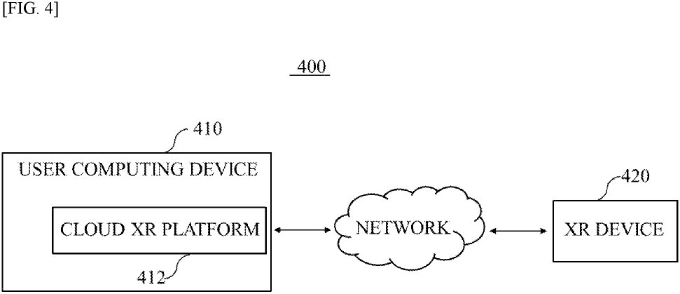

FIG. 4 is a diagram illustrating a cloud XR-based program virtualizing system according to another embodiment of the present disclosure.

Referring to FIG. 4, the program virtualizing system 400 may include a user computing device 410 and an XR device 420, and a cloud XR platform 412 may be installed in the user computing device 410.

FIG. 4 illustrates an example in which the cloud XR platform 412 is installed in each user’s personal computing device 410 (e.g., PC, notebook, tablet PC, etc.), the user computing device 410 directly transmits the 3D image to the XR device 420, and the command input from the XR device 420 or the request signal according to the input command is directly transmitted to the user computer device 410. The user computing device 410 on which the cloud XR platform 412 is installed may be a cloud PC. Hereinafter, for the convenience of description, the contents that are different from FIG. 1 will be mainly described.

The user computing device 410 is a computer controlled by the user, and may be connected to the XR device 420 through a network to exchange data. In an embodiment, the user computing device 410 may be connected to the XR device 420 through a wireless network such as Bluetooth, WiFi, and 5G communication, and may transmit/receive data to and from the XR device 420 through the network.

The user computing device 410 is operated by an operating system (OS), and may execute various application programs and process processes on the OS. In addition, the user computing device 410 may be implemented to operate through the cloud XR-based program virtualizing method according to the present disclosure. The XR application (agent) operating by interworking with the cloud XR platform 412 and the cloud XR platform 412 may be installed in the user computing device 410. The XR application (agent) installed in the user computing device 410 may interwork with the cloud XR platform 412 to execute the application program, and capture processes for each individual program while executing the application program. Alternatively, the XR application (agent) installed in the user computing device 410 may capture an execution screen while executing the application program. The XR application (agent) of the user computing device 410 may generate capture data and transmit the generated capture data to the cloud XR platform 412.

In an embodiment, the user computing device 410 may receive an application program execution request signal from the XR device 420. For example, the XR application (agent) of the user computing device 410 may receive the application program execution request signal from the XR device 420.

The XR device 420 may correspond to a user terminal capable of reproducing AR/VR images. The XR device 420 may be connected to the cloud XR platform 412 of the user computing device 410 through the network to exchange data.

The XR device 420 may be implemented to operate through the cloud XR-based program virtualizing method according to the present disclosure. The XR device 420 may reproduce the 3D image received from the cloud XR platform 412 by interworking with the cloud XR platform 412 of the user computing device 410.

In an embodiment, the XR device 420 may reproduce the 3D virtual space, and may reproduce the 3D image in which the application program execution screen is integrated in the 3D virtual space. In an embodiment, the XR device 420 may perform a specific operation for virtualization of the cloud XR-based program according to the present disclosure while reproducing the 3D virtual space.

For example, the XR device 420 may generate virtual input means (e.g., a virtual keyboard, a virtual mouse, etc.) in a virtual space under the control of the user and receive a user’s command through the virtual input means. In another embodiment, the XR device 420 may receive a user’s command through hardware input means (e.g., a Bluetooth keyboard, a Bluetooth mouse, etc.). In another embodiment, the XR device 420 may receive a user’s command through object tracking (e.g., hand tracking, head tracking, etc.).

The XR device 420 may generate a signal (e.g., a command signal, a motion signal, an application program execution request signal, etc.) according to the command received through the input means and transmit the generated signal to the user computing device 410. The user computing device 410 may receive the corresponding request signal to generate the execution screen of the corresponding application program, and transmit, to the XR device 420, the 3D image in which the application program execution screen is integrated in the 3D virtual space. In this case, the cloud XR platform 412 of the user computing device 410 may encode the generated 3D image and then transmit the encoded 3D image to the XR device 420, and the XR device 420 may receive and decode the 3D image and then reproduce the decoded 3D image. To this end, the XR device 420 may install and execute the XR application (client) that operates by interworking with the cloud XR platform 412 of the user computing device 410.

In an embodiment, the XR device 420 may be implemented to include a 6 degrees of freedom (DoF) sensor for user’s motion information. In addition, the XR device 420 may be implemented by further including various sensors as necessary. For example, the XR device 420 may further include a GPS sensor, a motion sensor, and the like. In another embodiment, the XR device 420 may receive user’s motion information from the 6 DoF sensor operating outside.

The cloud XR platform 412 may correspond to a program that transmits a 3D image including a virtual space to the XR device 420 through a network. In one embodiment, the cloud XR platform 412 may directly execute an application program installed in the cloud XR platform 412 according to a request received from the XR device 420, and transmit, to the XR device 420, the 3D image in which the execution screen of the corresponding application program is integrated in the virtual space. In another embodiment, the user computing device 410 may execute the application program installed in the user computing device 410 according to the request of the XR device 420, and the XR application (agent) may generate capture data while executing the application program and transmit the generated capture data to the XR platform 412. The cloud XR platform 412 may transmit, to the XR device 420, the 3D image in which the execution screen of the corresponding application program is integrated in the virtual space based on the capture data received from the XR application (agent).

The user computing device 410 may receive the 6 DoF signal as the user’s motion information from the XR device 420, and the cloud XR platform 412 may generate an image responding to the user’s motion based on the received 6 DoF signal and transmit the generated image to the XR device 420. To this end, the cloud XR platform 412 may install and execute the XR application that operates by interworking with the XR device 420.

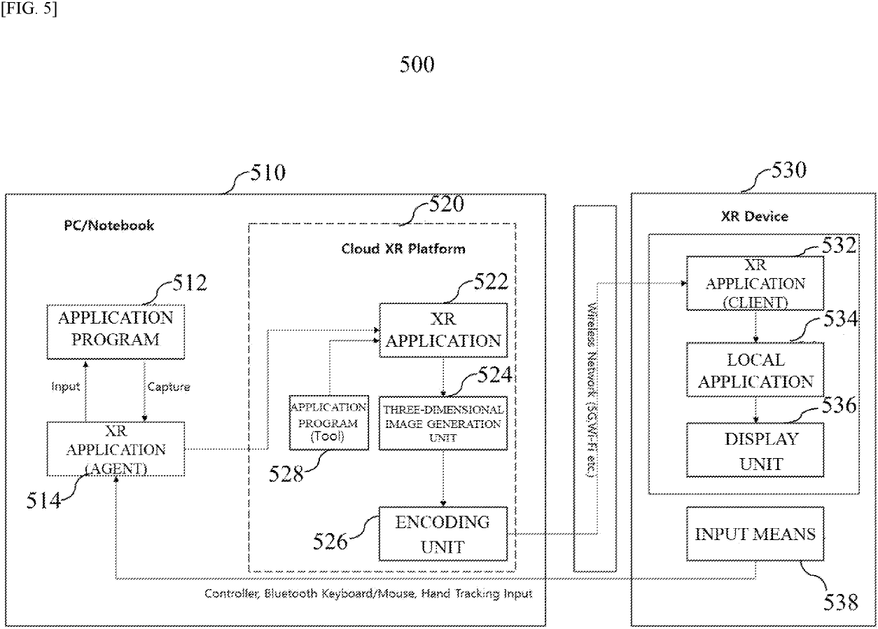

FIG. 5 is a diagram for explaining a functional configuration of the cloud XR-based program virtualizing system of FIG. 4 according to another embodiment of the present disclosure.

Referring to FIG. 5, a cloud XR-based program virtualizing system 500 may include a user computing device 510 and an XR device 530. The user computing device 510 includes an application program 512, an XR application (agent) 514, and an XR platform 520. The cloud XR platform 520 may include an XR application 522, a 3D image generation unit 524, an encoding unit 526, and an application program 528. The XR device 530 may include an XR application (client) 532, a local application 534, a display unit 536, and input means 538. Hereinafter, for the convenience of description, the contents that are different from FIG. 3 will be mainly described.

The XR application (agent) 514 interworks with the XR device 530 and the cloud XR platform 520 to perform a cloud XR-based program virtualizing method according to the present disclosure. When the information on the execution target application program 512 and the execution request signal of the corresponding application program 512 are received from the XR device 530, the user computing device 510 executes the corresponding application program 512. The XR application (agent) 514 may generate capture data while executing the application program 512 and transmit the capture data to the cloud XR platform 520.

The cloud XR platform 520 may generate a 3D virtual space according to the request signal received from the XR device 530 and may generate a URL that may access the corresponding 3D virtual space. The cloud XR platform 520 may provide an image of the same 3D virtual space to at least one or more XR devices 530 connected to the corresponding URL.

The XR application 522 interworks with the XR application (agent) 514 and the XR device 530 to perform computing, processing, rendering, and the like. The cloud XR platform 520 may execute the XR application 522 according to the request signal input through the XR device 430. The XR application 522 renders the 3D virtual space while being executed.

The 3D image generation unit 524 generates a virtual space image based on the rendered 3D virtual space, and the encoding unit 526 encodes the generated virtual space image and transmits the encoded space image to the remote XR device 530.

In an embodiment, the XR application 522 may render a user personal identification object customized by the user, and the 3D image generation unit 524 may generate the virtual space image including the user personal identification object based on the rendered user personal identification object and the 3D virtual space. In one embodiment, when there is more than one participant connected to the same 3D virtual space, the XR application 522 may render a participant personal identification object customized by the participant, and the 3D image generation unit 524 may generate a virtual space image including a user personal identification object and a participant personal identification object.

In an embodiment, when the application program (tool) 528 installed in the cloud XR platform or the application program 510 of the user computing device 512 is executed, the XR application 522 renders an execution screen of the corresponding application program. The 3D image generation unit 524 generates one 3D image by integrating the rendered 3D virtual space and the application program execution screen, and the encoding unit 526 encodes the generated 3D image and transmits the encoded 3D image to the XR device 530.

For example, when the user computing device 510 receives the execution request signal of the application program 512 installed in the user computing device 510 from the XR device 530, the XR application (agent) 514 executes the corresponding application program 512. In an embodiment, the execution request signal may include information on the execution target application program. The XR application (agent) 514 generates capture data while executing the application program and transmits the capture data to the user computing device 510. When a command signal for the application program 512 is received from the XR device 530, the XR application (agent) 514 transmits the command signal to the application program 512 and allows the corresponding application program 512 to execute the command.

When the user computing device 510 receives the execution request signal of the application program 528 installed in the XR platform 520 from the XR device 530, the XR application (agent) 514 transmits the application program 528 of the application program 528 to the user computing device 510. In an embodiment, the execution request signal may include information on the execution target application program. When the execution request signal is received, the XR application 522 executes the corresponding application program and renders the execution screen of the corresponding application program.

The 3D image generation unit 524 generates one 3D image by integrating the rendered 3D virtual space and the application program execution screen, and the encoding unit 526 encodes the generated 3D image and transmits the encoded 3D image to the XR device 530.

The cloud XR platform 520 may transmit the 3D image to the XR device 530, and the XR device 510 may decode and reproduce the received 3D image.

The XR application (client) 532 interworks with the cloud XR platform 520 under the user’s control to access the 3D virtual space through the URL, and receives the 3D image from the cloud XR platform 520. The XR application (client) 532 may generate a signal (e.g., a command signal, a motion signal, an application program execution request signal, etc.) according to the received command based on the command received through the input means and transmit the generated signal to the user computing device 510.

The local application 534 executes basic operations and functions of the XR device 530. The local application 534 may decode the 3D image received through the XR application (client) 532.

The display unit 536 displays the decoded 3D image so that a user may experience the 3D virtual space.

The input means 538 may receive a command under the user’s control, generate a signal (e.g., a command signal, a motion signal, an application program execution request signal, etc.) according to the received command, and transmit the generated signal to the user computing device 510. In one embodiment, the input means 538 may include virtual input means such as a virtual keyboard and a virtual mouse, hardware input means (e.g., Bluetooth keyboard, Bluetooth mouse, etc.), and input means such as object tracking (e.g., hand tracking, head tracking, etc.).

For example, the input means 538 may generate a virtual keyboard in a 3D virtual space displayed through the display unit 536 to provide a command input function in the virtual space. The virtual keyboard may interwork with the hand tracking function to input a command using a user’s hand on a keyboard in the virtual space. The input means 538 may be connected to a Bluetooth keyboard, and when a command is input through the corresponding keyboard, the input means 538 may transmit a signal according to the received command to the user computing device 510. In the case of the XR device 530 supporting the hand tracking, the input means 538 may receive a motion-based command through the hand tracking.

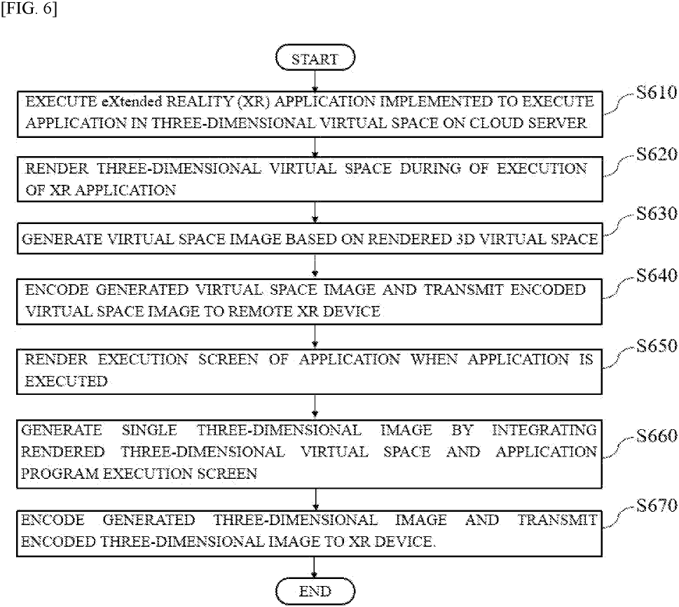

FIG. 6 is a flowchart for explaining an embodiment of a cloud XR-based program virtualizing method according to the present disclosure.

Referring to FIGS. 6 and 3, the cloud server 320 executes the XR application implemented to execute the application in the three-dimensional virtual space (step S610).

The cloud server 320 renders a 3D virtual space while executing the XR application (step S620), and generates a virtual space image based on the rendered 3D virtual space (step S630). The cloud server 320 encodes the generated virtual space image and transmits the encoded virtual space image to the remote XR device 330 (step S640).

When the application program is executed according to the application program execution request signal received from the XR device 330, the cloud server 320 renders the execution screen of the corresponding application program (step S650). For example, when the execution request signal of the application program installed in the remote user computing device 310 is received from the XR device 330, the cloud server 320 transmits the execution request signal of the application program to the user computing device 310. The cloud server 320 receives capture data captured while executing the application program in the user computing device 310, and renders an execution screen of the application program based on the received capture data.

When the execution request signal of the application program installed on the cloud XR platform of the cloud server 320 is received from the XR device 330, the cloud server 320 executes the corresponding application program and renders the execution screen of the corresponding application program.

The cloud server 320 generates one 3D image by integrating the rendered 3D virtual space and the application program execution screen (step S660), encodes the generated 3D image, and transmits the encoded 3D image to the XR device 330 (step S670). The XR device 330 may decode and reproduce the received 3D image. A detailed description of each step is as described in FIG. 3.

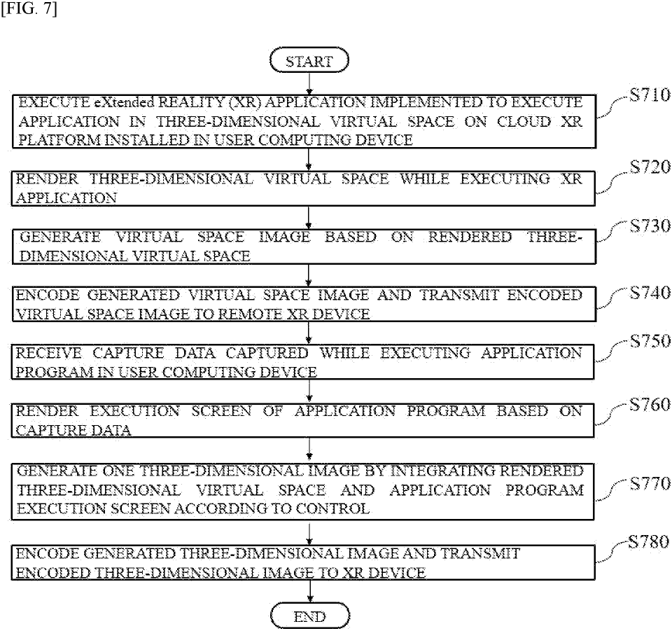

FIG. 7 is a flowchart for explaining another embodiment of a cloud XR-based program virtualizing method according to the present disclosure.

Referring to FIGS. 7 and 5, the cloud XR platform 520 installed in the user computing device 510 executes the implemented XR application to execute the application in the three-dimensional virtual space (step S710).

The cloud XR platform 520 renders a 3D virtual space while executing the XR application (step S720), and generates a virtual space image based on the rendered 3D virtual space (step S730). The cloud XR platform 520 encodes the generated virtual space image and transmits the encoded virtual space image to the remote XR device 530 (step S740).

The cloud XR platform 520 receives the capture data captured while executing the application program in the user computing device 510 (step S750), and renders the execution screen of the corresponding application program based on the capture data (step S760).

For example, when the execution request signal of the application program 512 is received from the XR device 530, the user computing device 510 executes the corresponding application program 512, and the XR application (agent) 514 generates the capture data while executing the application program 512 and transmits the generated capture data to the cloud XR platform 520.

When the execution request signal of the application program 528 installed in the cloud XR platform 520 is received from the XR device 530, the XR application (agent) 514 transmits the execution request signal of the application program 528 to the cloud XR platform 520. When the execution request signal is received, the XR platform 520 executes the corresponding application program and renders the execution screen of the corresponding application program.

The cloud XR platform 520 generates one 3D image by integrating the rendered 3D virtual space and the application program execution screen under the control (step S770), encodes the generated 3D image, and transmits the encoded 3D image to the XR device 530 (step S780). The XR device 530 may decode and reproduce the received 3D image. A detailed description of each step is as described in FIG. 5.

Although exemplary embodiments of the present invention have been disclosed hereinabove, it may be understood by those skilled in the art that the present invention may be variously modified and altered without departing from the scope and spirit of the present invention described in the following claims.

What is claimed is:

1. A cloud XR-based program virtualizing method, comprising:
executing an eXtended reality (XR) application implemented to execute an application in a three-dimensional (3D) virtual space on a cloud server;
rendering a 3D virtual space while executing the XR application;
generating a virtual space image based on the rendered 3D virtual space;
encoding the generated virtual space image and transmitting the encoded virtual space image to a remote XR device;
rendering an execution screen of the application when the application is executed;
generating one 3D image by integrating the rendered 3D virtual space and the application program execution screen; and
encoding the generated 3D image and transmitting the encoded 3D image to the XR device.

2. The cloud XR-based program virtualizing method of claim 1, wherein the rendering of the 3D virtual space includes rendering a virtual space including a personal room and a conference room.

3. The cloud XR-based program virtualizing method of claim 1, wherein the generating of the virtual space image includes:
rendering a user personal identification object customized by the user; and
generating a virtual space image including the user personal identification object based on the rendered user personal identification object and the 3D virtual space.

4. The cloud XR-based program virtualizing method of claim 3, wherein the generating of the virtual space image further includes rendering a participant personal identification object customized by a participant who accesses the virtual space, and
the generating of the virtual space image including the personal identification object includes generating a virtual space image including the user personal identification object and the participant personal identification object.

5. The cloud XR-based program virtualizing method of claim 1, wherein the rendering of the execution screen includes:
transmitting an execution request signal to the user computing device when the execution request signal of an application installed in a remote user computing device is received;
receiving capture data captured while executing the application program in the user computing device; and
rendering the execution screen of the application program based on the received capture data.

6. The cloud XR-based program virtualizing method of claim 5, wherein the capture data is process capture data obtained by capturing a process for each individual program executed in the user computing device.

7. The cloud XR-based program virtualizing method of claim 5, wherein the capture data is screen capture data obtained by capturing the screen of the user computing device.

8. The cloud XR-based program virtualizing method of claim 5, wherein the transmitting of the execution request signal to the user computing device includes receiving the execution request signal from the XR device.

9. The cloud XR-based program virtualizing method of claim 1, wherein the rendering of the execution screen includes:
executing the application program when the execution request signal of the application installed on the cloud server is received; and
rendering the execution screen of the application program.

10. The cloud XR-based program virtualizing method of claim 9, wherein the application program includes a memo program, a whiteboard program, a screen program, a 3D viewer program, a voice chat program, a pointer program, a keyboard input program, or an object tracking program.

11. A cloud XR-based program virtualizing method, comprising:
executing an eXtended reality (XR) application implemented to execute an application in a three-dimensional (3D) virtual space on a cloud XR platform installed in a user computing device;
rendering a 3D virtual space while executing the XR application;
generating a virtual space image based on the rendered 3D virtual space;
encoding the generated virtual space image and transmitting the encoded virtual space image to a remote XR device;
receiving capture data captured during an execution of an application program in the user computing device;
rendering an execution screen of the application program based on the capture data;
generating one 3D image by integrating the rendered 3D virtual space and the application program execution screen according to control; and
encoding the generated 3D image and transmitting the encoded 3D image to the XR device.
